(19) United States
(12) Patent Application Publication
(10) Pub. No.: US 2025/0040527 A1
(43) Pub. Date: Feb. 6, 2025

(54) FISHING REEL, FISHING ROD, MOTION CAPTURE DEVICE, AND METHOD FOR OBTAINING FISHING ROD FISHING EVENTS

(71) Applicant: GUANGDONG COROS SPORTS TECHNOLOGY CO., LTD, Dongguan (CN)

(72) Inventors: Haotian NIU, Dongguan (CN); Yu TANG, Dongguan (CN); Hongbo XU, Dongguan (CN); Xuan RAO, Dongguan (CN)

(21) Appl. No.: 18/923,670

(22) Filed: Oct. 22, 2024

Related U.S. Application Data
(63) Continuation of application No. PCT/CN2022/097705, filed on Jun. 8, 2022.

(51) Int. Cl. A01K 89/015

(52) U.S. Cl. CPC A01K 89/0183

(57) ABSTRACT

A fishing reel includes a body frame, a line winding mechanism, and a motion capture device. The line winding mechanism is at least partially arranged in the body frame and configured to move relative to the body frame to wind fishing line. The motion capture device is arranged at the line winding mechanism and configured to collect motion data of the line winding mechanism.

### CROSS-REFERENCE TO RELATED APPLICATION

The present application is a continuation of International Application No. PCT/CN2022/097705, filed Jun. 8, 2022, the entire content of which is incorporated herein by reference.

### TECHNICAL FIELD

The present disclosure generally relates to the fishing gear technology field and, more particularly, to a fishing real, a fishing rod, a motion capture device, and a method for obtaining fishing rod fishing events.

### BACKGROUND

In fishing activities, especially in lure fishing, more and more users start to collect and share fishing-related data, such as fishing actions like casting bait and reeling in the line, to improve fishing skills. However, the collection of such data primarily relies on manual recording by the user. On one hand, this type of recording adds extra burden to the fishing process, and on the other hand, manual recording is prone to errors, and relevant data is easily lost.

Usually, a plurality of cameras are used to capture fishing actions, and the actions are then analyzed and recorded. However, the above solution relies on a plurality of mid-size and large-size accessories, such as cameras. On one hand, adding such equipment greatly increases fishing costs. On another hand, the mid-size and large-size accessories are difficult to carry and mount, which results in inconvenience in fishing activities. Since the plurality of cameras needs to be set up in a plurality of directions, the operation is inconvenient.

### SUMMARY

In accordance with the disclosure, there is provided a fishing reel includes a body frame, a line winding mechanism, and a motion capture device. The line winding mechanism is at least partially arranged in the body frame and configured to move relative to the body frame to wind fishing line. The motion capture device is arranged at the line winding mechanism and configured to collect motion data of the line winding mechanism.

In accordance with the disclosure, there is provided a motion capture device including a motion sensor. The motion sensor is configured to collect motion data of a line winding mechanism of a fishing reel and send the motion data to a processing unit.

In accordance with the disclosure, there is provided a method for obtaining fishing rod fishing events. The method includes obtaining motion data of a winding mechanism at least partially arranged in a body frame of a fishing reel of a fishing rod and determining a fishing event according to the motion data. The motion data is collected by a motion capture device arranged at the line winding mechanism.

### BRIEF DESCRIPTION OF THE DRAWINGS

FIG. 1 is a partial schematic diagram of a fishing rod with a motion capture device arranged at a lever drag body according to some embodiments of the present disclosure.

FIG. 2 is a partial schematic diagram of a fishing rod with a motion capture device arranged at a lever according to some embodiments of the present disclosure.

FIG. 3 is a schematic diagram of a spool with a motion capture device arranged at the spool according to some embodiments of the present disclosure.

FIG. 4 is a partial schematic diagram of a fishing rod with a motion capture device arranged at a transmission device according to some embodiments of the present disclosure.

### REFERENCE NUMERALS

| | | |
|---|---|---|
| 100 Rod body | | |
| 1 Body frame | | |
| 2 Line winding mechanism | 21 Drive device | 211 Lever drag assembly |
| 2111 Lever drag body | 2112 Lever | 2113 Fixation nut |
| 212 Rotation shaft | 22 Spool | 23 Transmission device |
| 3 Motion capture device | 31 Motion sensor | 32 Signal transceiver |
| | | module |
| 33 Processor module | | |

### DETAILED DESCRIPTION OF THE EMBODIMENTS

The technical solution of the present disclosure is described in connection with the accompanying drawings. The described embodiments are only some of embodiments of the present disclosure.

A lure fishing process primarily includes a casting process and a reeling process. The casting process in lure fishing can be mostly related to the overall movement of the fishing rod. The main purpose of a casting action is to cast a bait to a target fishing area. Smart wearable equipment can be arranged at the fishing rod or a handheld area of the fishing rod. The casting action can be recognized through the acceleration sensor of the smart wearable equipment. However, to improve fish hook skills, the reeling action is related.

As shown in FIG. 1 to FIG. 4, embodiments of the present disclosure provide a fishing rod. The fishing rod includes a rod body 100 and a fishing reel arranged at the rod body 100. The fishing rod can be used for lure fishing. The fishing rod is economical and light, and can be configured to assist the user in determining a fishing event during the fishing process, which is beneficial for improving the user experience.

Embodiments of the present disclosure further provide a fishing reel applied to the fishing rod. The fishing reel includes a body frame 1, a line winding mechanism 2, and a motion capture device 3. The line winding mechanism 2 can be at least partially arranged in the body frame 1. The line winding mechanism 2 can move relative to the body frame 1 to wind the fishing line. The motion capture device 3 can be arranged at the line winding mechanism 2 and can be configured to record and collect the motion data of the line winding mechanism 2. The motion data can be used to determine the fishing event.

The line winding mechanism 2 can be arranged at the body frame 1 of the fishing reel. The line winding mechanism 2 can be configured to wind the fishing line through the movement of the line winding mechanism 2 relative to the body frame 1. By arranging the motion capture device 3 at the line winding mechanism 2, the motion capture device 3 can be configured to capture the motion data of the line winding mechanism 2. The motion data can be used to determine the fishing event to provide the user with finer recognition and recording. Meanwhile, the fishing reel can have a simple structure and low cost and can be easy to carry and operate. Especially in the lure fishing process, with the above fishing reel, the user can more accurately recognize a plurality of actions of the line winding mechanism 2 to obtain a finer fishing experience.

The change in the acceleration signal during the casting process can be solely used to recognize the casting signal to count the casting actions. However, for the fishing actions, especially a plurality of operation skill types of actions in the lure fishing cannot be finely recognized and recorded. In some embodiments, to determine the fishing event more accurately, the motion data can at least include a rotation feature of the line winding mechanism 2.

In fishing scenarios, such as in lure fishing, during the retrieval process of the bait and fishing line, the motion feature of the line winding mechanism 2 of winding the fishing line can be important for determining the fishing events. For example, the rotation feature of the line winding mechanism 2 can be the feature of the line winding mechanism 2 during the retrieval process of the bait and fishing line. By obtaining the rotation feature of the line winding mechanism 2, the user can be assisted to recognize and determine the fishing event.

The motion data can also include a movement feature of the line winding mechanism 2. For example, since the line winding mechanism 2 is arranged at the rod body 100 of the fishing rod, the movement feature of the line winding mechanism 2 can be the casting action of the fishing rod. The casting action of the fishing rod can be a fundamental feature for recognizing and determining the fishing event in lure fishing. In some other embodiments, the movement feature of the line winding mechanism 2 can also be obtained through other devices. The location of the data capture device may not be limited to the line winding mechanism 2, as long as the movement feature of the fishing rod can be obtained.

In some embodiments, the motion capture device 3 of the fishing reel can simultaneously obtain the rotation feature and the movement feature of the line winding mechanism 2, to more accurately assist the user in recognizing and determining the fishing events. In embodiments of the present disclosure, the motion capture device 3 can be used to capture the rotation feature and the movement feature of the winding mechanism 2 simultaneously. Compared to the previous technology, less devices are required, which avoids complex operations because the cooperation between the plurality of devices needs to be considered when the plurality of devices are used. Meanwhile, the structure of the fishing rod can be simplified, and the cost of the fishing rod can be lowered.

The motion capture device 3 can be detachably mounted at the line winding mechanism 2. By detachably connecting the motion capture device 3 to the line winding mechanism 2, on one hand, the user can replace the battery for the motion capture device 3 conveniently, and on another hand, the motion capture device 3 can be easily disassembled and maintained when having a malfunction.

To realize the detachable and fixed connection between the motion capture device 3 and the line winding structure 2, the connection between the motion capture device 3 and the line winding mechanism 2 can be mechanical, such as a threaded connection, a key-pin connection, a snap connection, or a hinge connection, or a magnetic connection such as a magnetic attraction connection.

In some embodiments, the line winding mechanism 2 can include a drive device 21 and a spool 22. The fishing line can be wound around the spool 22. The drive device 21 can drive the spool 22 to rotate to retrieve and release the fishing line on the spool 22. Thus, the action of retrieving the cast bait can be performed.

The motion capture device 3 can be arranged at the drive device 21 or the spool 22. Since the drive device 21 and the spool 22 can move relative to the body frame 1, the motion capture device 3 can be arranged at the drive device 21 or the spool 22 to obtain more comprehensive motion data.

In some embodiments, the drive device 21 includes a lever drag assembly 211 and a rotation shaft 212. The lever drag assembly 211 is transmission-connected to the spool 22 via the rotation shaft 212. The user can operate the lever drag assembly 211 to drive the rotation shaft 212 and spool 22 to rotate. The motion capture device 3 can be arranged at the lever drag assembly 211 or the rotation shaft 212.

The lever drag assembly 211 includes a lever drag body 2111 and a lever 2112 rotatably arranged at the lever drag body 2111. The lever 2112 can be configured to provide the user with handheld space. The lever drag body 2111 can be arranged with the rotation shaft 212 at an included angle to facilitate the operation of the user. Thus, the operation of the lever drag assembly 211 can be more convenient with less power.

In some embodiments, the middle portion of the lever drag body 2111 is connected to the rotation shaft 212. Two ends of the lever drag body 2111 include levers 2112, which are symmetrically arranged about the central axis of the rotation shaft 212 to accommodate users with different operation habits and consider aesthetic appeal. To realize the connection between the lever drag body 2111 and the rotation shaft 212. A fixation nut 2113 is arranged in the middle of the lever drag body 2111. The fixation nut 2113 can be connected to the rotation shaft 212.

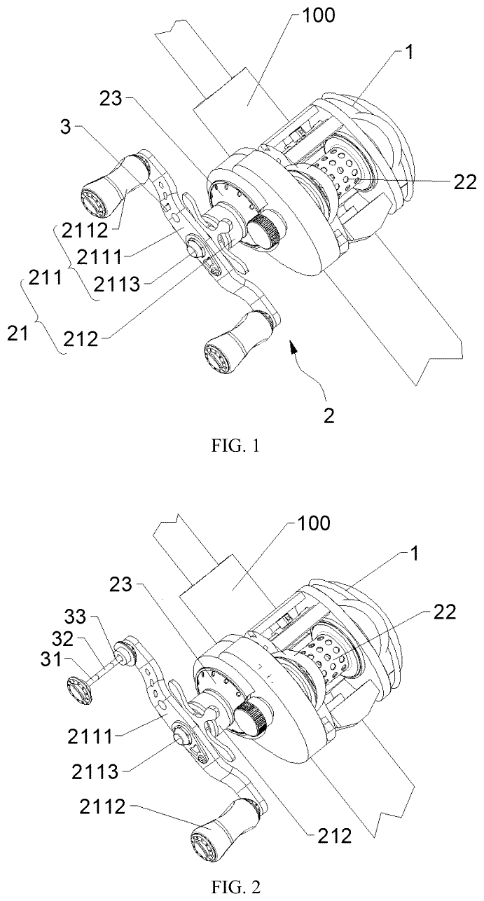

For example, as shown in FIG. 1, the motion capture device 3 is arranged at the lever drag body 2111, or as shown in FIG. 2, motion capture device 3 is arranged at the lever 2112. When the motion capture device 3 is arranged at the lever 2112, the motion capture device 3 can be arranged inside the lever 2112 to reduce the interference of the motion capture device 3 to the user operation.

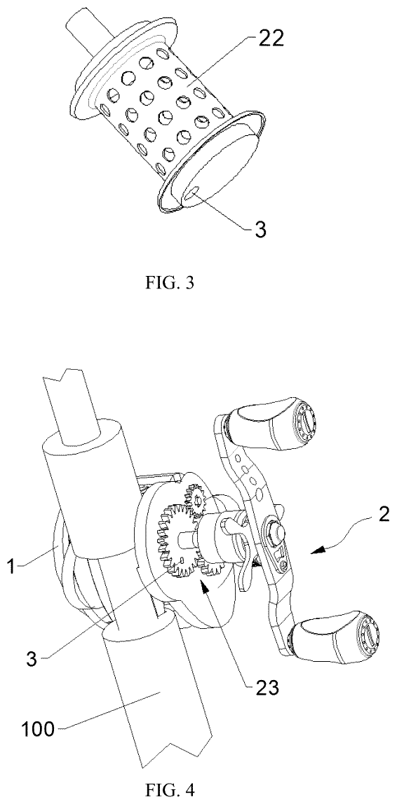

When the motion capture device 3 is arranged at the spool 22, as shown in FIG. 3, the motion capture device 3 is arranged on an outer side of the end surface of the spool 22. Then, the motion capture device 3 can be easier to install and maintain. In some other embodiments, the motion capture device 3 can be arranged on the inner side of the end surface of the spool 22. Then, the spool 22 can protect the motion capture device 3 to reduce the interference and impact of the structures outside the spool 22 to the motion capture device 3.

In some embodiments, the line winding mechanism 2 can include a drive device 21, a transmission device 23, and a spool 22. The transmission device 23 can be configured to transmit power between the line winding mechanism 2 and the spool 22 to change the drive power, drive direction, or drive torque of the drive device 21. The drive device 21 can drive the spool 22 to rotate via the transmission device 23 to wind the fishing line.

The motion capture device 3 can be arranged on the drive device 21, the transmission device 23, or the spool 22. Since the drive device 21, the transmission device 23, and the spool 22 move relative to the body frame 1, by arranging the motion capture device 3 at the drive device 21, the transmission device 23, or the spool 22, more comprehensive motion data can be obtained.

For example, as shown in FIG. 4, the transmission device 23 is a gear structure. When the motion capture device 3 is arranged at the transmission device 23, the motion capture device 3 can be arranged at any one gear of the gear structure, as long as the motion capture device 3 can be easily mounted. In embodiments of the present disclosure, the mounting position of the motion capture device 3 at the gear structure is not limited.

By using a fishing rod equipped with the above fishing reel during lure fishing, the motion capture device 3 can be configured to collect the rotation feature and the movement feature of the line winding mechanism 2. Thus, the overall fishing process can be finely recognized to realize the acquisition, recognition, and recording of the operation methods and fishing strategies during the lure fishing. The user can have a better experience. The fishing rod can require relatively few sensors, which effectively avoids the cooperation and interference among the plurality of sensors to cause the operation to be simpler.

Embodiments of the present disclosure further provide a method for obtaining fishing rod fishing events. The fishing rod can include the fishing reel. The fishing reel can include the body frame 1, the line winding mechanism 2 partially arranged at the body frame 1, and the motion capture device 3 arranged at the line winding mechanism 2. The line winding mechanism 2 can move relative to the body frame 1 to wind the fishing line. The method can include obtaining motion data of the line winding mechanism 2 and determining the fishing event according to the motion data. The motion data of the line winding mechanism 2 can be collected by the motion capture device 3.

In some embodiments, the motion data can include the rotation feature of the line winding mechanism 2. The rotation feature of the line winding mechanism 2 can be a feature of the line winding mechanism 2 when retrieving the bait and the fishing line. Obtaining the rotation feature of the line winding mechanism 2 can more comprehensively assist the user to recognize and determine the fishing events.

Determining the fishing event according to the motion data can include determining the fishing event as fish searching according to the rotation feature of the line winding mechanism 2.

Fish searching can include uniform retrieval. Uniform retrieval refers to retrieving the fishing line steadily at a certain speed, and the lure can move as a fish swimming. The fishing event can be recognized and determined by merely obtaining the rotation feature of the line winding mechanism 2 by the motion capture device 3.

As another optional method for obtaining fishing rod fishing events, the motion data can also include the movement feature of the line winding mechanism 2. Determining the fishing events according to the motion data can include determining the fishing event as fish luring or fish hooking according to the rotation feature and the movement feature of the line winding structure 2.

The fish luring event can include light shaking, slow stopping, or small jumping. Light shaking can refer to a slight shaking of the rod tip based on steady retrieval, the frequency can be shaking once when one circle line is retrieved or shaking one or two times when two or three circles of line are retrieved. Slow stopping can refer to stopping after one or two circles of line are retrieved based on the uniform line retrieval. Each stop can last 2 to 4 seconds, and then the line can be retrieved. Small jumping can refer to moving slightly up and down while retrieving the fishing line. Thus, the lure can mimic a jumping action at the bottom of the water. The fish hooking can refer to dragging the fishing rod with a large amplitude, quickly retrieving the fishing line until the fish is near the fishing spot, manually grabbing the fishing line, and pulling the fish to a hook position. The fish luring and fish hooking can be recognized and determined by simultaneously obtaining the rotation feature and the movement feature of the line winding mechanism 2.

The method for obtaining fishing rod fishing events can be applied to lure fishing. For example, the motion data of the line winding mechanism 2 during the line retrieval process can be precisely recognized to determine the fishing events more comprehensively. The motion capture device 3 can obtain the rotation feature and the movement feature of the line winding mechanism 2 to precisely determine the fishing event.

Embodiments of the present disclosure further provide the motion capture device applied to the fishing reel. As shown in FIG. 2 and FIG. 3, the fishing reel includes the body frame 1 and the line winding mechanism 2. The line winding mechanism 2 can be at least partially arranged in the body frame 1. The line winding mechanism 2 can move relative to the body frame 1 to wind the fishing line. The motion capture device 3 is arranged at the line winding mechanism 2. The motion capture device 3 includes a motion sensor 31. The motion sensor 31 can be configured to obtain the motion data of the line winding mechanism 2 and send the motion data to the processing unit to allow the processing unit to determine the fishing event according to the motion data.

The motion data can include the rotation feature and the movement feature of the line winding mechanism 2. By obtaining the rotation feature and the movement feature of the line winding mechanism 2, the processing unit can be configured to recognize and determine the fishing event more comprehensively.

In some embodiments, the motion capture device 3 can also include a signal transceiver module 32. The signal transceiver module 32 can be configured to facilitate the external communication for the motion capture device 3 to realize a data transmission function. The signal transceiver module 32 can be communicatively connected to the motion sensor 31 to send the motion data collected by the motion sensor 31 to the processing unit, and/or receive external attribute parameters from the processing unit to the motion capture device 3.

For example, the signal transceiver module 32 can be a short-range wireless communication device, such as Bluetooth or Near Field Communication (NFC). The signal transceiver module 32 can communicate with a terminal. The terminal can be a mobile phone or wearable equipment, such as a smartwatch or a fitness band.

In some embodiments, the motion capture device 3 can include a processor module 33. The signal transceiver module 32 can be configured to realize the external communication of the motion capture device 3 to realize the data transmission function. The signal transceiver module 32 can be communicatively connected to the motion sensor 31 to send the motion data obtained by the motion sensor 31 to the processing unit and/or receive the external attribute parameter from the processing unit to the motion capture device 3.

For example, the signal transceiver module 32 can be a short-range wireless communication device, such as Bluetooth or Near Field Communication (NFC). The signal transceiver module 32 can communicate with a terminal. The terminal can be a mobile phone or wearable equipment, such as a smartwatch or a fitness band.

In some embodiments, the motion capture device 3 can include the processor module 33. The signal transceiver module 32 can be communicatively connected to the processor module 33 to send the motion data obtained by the motion sensor 31 to the processor module 33. The processor module 33 can determine the fishing event according to the motion data.

The processing unit can be a processing unit built-in motion capture device 3, such as a processor module 33, or a processing unit of an external device communicatively connected to the motion capture device 3. For example, the external device communicatively connected to the motion capture device 3 can be a cellphone or wearable equipment, such as a smart watch and a wrist band.

When the motion capture device 3 is communicatively connected to the external device, the attributes of the fishing rod and the attributes of the bait corresponding to the fishing reel mounted with the motion capture device 3 can be manually inputted through the external equipment. The attribute of the fishing rod can include the type of the fishing rod, for example, the length and hardness of the fishing rod and the numbering of the fishing rod. The attribute of the bait can include different types of baits, such as hard bait, soft bait, and composite bait.

By connecting the motion capture device 3 to the external device, the external device can also serve as a platform to display to the user various fishing strategies derived from data obtained through different fishing conditions, different rods, baits, and different fishes, to share with the user.

As an optional solution for the motion capture device, the motion capture device 3 can also include a power supply module (not shown in the diagram), and the motion sensor 31, the signal transceiver module 32, and the processor module 33, which are electrically connected to the power supply module. The power supply module can provide power to the motion sensor 31, the signal transceiver module 32, and the processor module 33. For example, the power supply module can include a one-time battery or a two-time battery, the one-time battery can be a button cell, and the two-time battery can include a lithium battery.

As an optional solution for the motion capture device, the motion sensor 31 can be configured to detect an acceleration signal. In some embodiments, the motion sensor 31 can be a three-axis accelerometer. The three-axis accelerometer can detect the acceleration to obtain the motion data to recognize and determine the fishing events.

The three-axis accelerometer can recognize key positions of the casting motion in a time sequence. For instance, the casting process can last for 1 second, the back of the fishing rod can be lifted up during the first 200 ms. Then, the fishing rod can be in a relative still status. The relative still status can be key position 1 of the casting motion. The detection value of the three-axis accelerometer can be g without force being applied, and the three-axis accelerometer can only detect gravity. During 200 ms-1 s, the casting motion can be performed. The start position and the end position of the motion can be key position 2 and key position 3 of the casting motion. Then, the acceleration signal along the axial directions of the two levers 2112 in the three-axial accelerometer can be in a reverse attitude with the acceleration signal along the axial direction of the lever drag body 2111. The wave can be filtered, and the noise can be removed through the pre-processing. The acceleration signals at key position 2 and key position 3 can be low-frequency signals. The low-frequency signals can be used to recognize the reverse attitude. Thus, once the acceleration signals at the three key positions, the casting can be determined.

For example, for a uniform retrieval event, the lever 2112 can be uniformly rotated to retrieve the fishing line. The three-axial acceleration signal can include calculating a difference between the acceleration signal along the axial direction of the lever drag body 2111 and the acceleration signal of any one shaft perpendicular to the axial direction of the lever drag body 2111, and obtaining a maximum difference during the process of changing caused by the orthogonal phase difference by performing subtraction on the signals of the two orthogonal axes. After four maximum differences are extracted, the lever 2112 can be considered to have rotated one circle. Thus, during the line retrieval process, when a plurality of groups of four maximum values are obtained consecutively, the lever 2112 can be considered to rotate uniformly. That is, the uniform retrieval motion can be performed.

For the slow-stop event, the difference in performance of the three-axis acceleration signal compared to the uniform retrieval event can be that after extracting a first group of four maximum values, a second group of four maximum values are continued to be extracted after a time interval. Then, it can be determined that the slow-stop motion has occurred.

For the “light shake” event, the motion feature of the light shake can include after the line is retrieved for one or more circles, a slight shaking motion occurs. The acceleration signal can exhibit differently. For example, the difference between the acceleration signal along the axial direction of the lever drag body 2111 and the acceleration signal along any one axis perpendicular to the axial direction of the lever drag body 2111 calculated, and the maximum difference during the process of changing caused by the orthogonal phase difference obtained. After four maximum values (i.e., maximum differences) are extracted, the lever 2112 can be determined to have rotated one circle. Then, a second-order norm addition is performed on the three-axis accelerations. If two symmetrical peaks occur in the second-order norm sum, and the two symmetrical peaks are after the four maximum values based on the time sequence, it can be determined that slight shake has occurred.

For the “small jump” event, the acceleration signal can be like the following. The difference between the acceleration signal along the axis of the rod body 2111 and the acceleration signal along any one axis perpendicular to the axial direction of the lever drag body 2111 is calculated, and the maximum difference during the process of changing caused by the orthogonal phase difference is obtained by performing the subtraction on the signals of the two orthogonal axes. After four maximum values (i.e., maximum differences) are extracted, the lever 2112 can be determined to have rotated one circle. Then, the second-order nom addition is performed on the three-axis acceleration signals. If symmetrical peaks occur in the second-order norm sum, and the symmetrical peaks are between one of two of four maximum values, it can be determined that small jump event has occurred.

For the fish hooking event, after the fish is hooked, the user will reel in the fish to be near the fishing spot. To fetch the fish, the length of the released line can be longer than the length of the retrieved line. For example, the length of the released line can be 1 to 2 meters longer than the length of the retrieved line. Based on this, by calculating the difference between the acceleration signal of the three-axis acceleration signal along the axial direction of the lever drag body 2111 and the acceleration signal of any one axis perpendicular to the axial direction of the lever drag body 2111, and performing subtraction on the signals of the two orthogonal axes, the maximum difference during the process of changing caused by the orthogonal phase difference can be obtained. After four maximum values (i.e., maximum differences) are obtained, the lever 2112 can be determined to have rotated one circle. Then, the line release circles can be counted for the fishing reel to calculate the length of the released line. The circles of line retrieving can be synchronously counted to calculate the length of the retrieved line. When the difference between the length of the released line and the length of the retrieved line is greater than a length threshold, e.g., the difference between the length of the released line and the length of the retrieved line is greater than any value from 1 to 2 meters, the motion can be determined to be fish hooking.

Embodiments of the present disclosure further provide a fishing rod, including the rod body 100 and the fishing reel. The motion capture device 3 can be arranged at the line winding mechanism of the fishing reel to more accurately assist the user to recognize and determine the fishing events.

In description of the present disclosure, the orientations or position relationship indicated by the terms such as “center,” “upper,” “lower,” “left,” “right,” “vertical,” “horizontal,” “inner,” and “outer” can be based on the orientation or position relationship shown in the accompanying drawings to merely simplify the description of the present disclosure not to indicate or imply that the device or elements must have a certain orientation or be constructed or operated in a certain orientation. Thus, the terms cannot be considered as limiting to the present disclosure. In addition, the terms “first” and “second” are merely for description purposes and cannot considered as indicating or implying relative importance. The terms “first position” and “second position” are two different positions.

In the description of the present disclosure, unless otherwise specified or limited, a first feature being “on” or “under” a second feature can include that the first feature directly contacts the second feature, or the first feature does not directly contact the second feature but the first feature contacts the second feature through another feature therebetween. The first feature being “on”, “above,” and “over” the second feature can include that the first feature is right above or diagonally above the second feature, or the horizontal height of the first feature is higher than the horizontal height of the second feature. The first feature being “under”, “below,” and “beneath” the second feature can include that the first feature is right below or diagonally below the second feature, or the horizontal height of the first feature is merely lower than the horizontal height of the second feature.

In the description of the present disclosure, unless otherwise specified or limited, the terms “installation,” “connection,” and “coupled” should be understood broadly, for example, fixed connection, detachable connection, integral connection, mechanical connection, electrical connection, direct connection, indirect connection through an intermediate medium, or internal communication of two elements. For those skilled in the art, the meaning of the terms in the present disclosure can be understood as needed.

What is claimed is:

1. A fishing reel comprising:
a body frame;
a line winding mechanism at least partially arranged in the body frame and configured to move relative to the body frame to wind fishing line; and
a motion capture device arranged at the line winding mechanism and configured to collect motion data of the line winding mechanism.

2. The fishing reel according to claim 1, wherein the motion data at least includes a rotation feature of the line winding mechanism.

3. The fishing reel according to claim 1, wherein the motion data includes a movement feature of the line winding mechanism.

4. The fishing reel according to claim 1, wherein the motion capture device is detachably arranged at the line winding mechanism.

5. The fishing reel according to claim 1, wherein the line winding mechanism includes:
a spool; and
a drive device configured to drive the spool to rotate to wind the fishing line.

6. The fishing reel according to claim 5, wherein the motion capture device is arranged at the drive device or the spool.

7. The fishing reel according to claim 5, wherein:
the line winding mechanism further includes a transmission device; and
the drive device is configured to drive the spool via the transmission device.

8. The fishing reel according to claim 7, wherein the motion capture device is arranged at the drive device, the transmission device, or the spool.

9. The fishing reel according to claim 5, wherein the drive device includes:
a rotation shaft; and
a lever drag assembly transmission-connected to the spool via the rotation shaft, the motion capture device being arranged at the lever drag assembly or the rotation shaft.

10. The fishing reel according to claim 9, wherein the lever drag assembly includes:
a lever drag body; and
a lever rotatably arranged at the lever drag body, the lever drag body and the rotation shaft being arranged at an angle with respect to each other, the lever and the lever drag body being arranged an angle with respect to each other, and the motion capture device being arranged at the lever drag body or the lever.

11. A fishing rod comprising:
a rod body; and
the fishing reel according to claim 1 arranged at the rod body.

12. A motion capture device comprising:
a motion sensor configured to collect motion data of a line winding mechanism of a fishing reel and send the motion data to a processing unit.

13. The motion capture device according to claim 12, wherein the motion data includes a rotation feature and a movement feature of the line winding mechanism.

14. A fishing rod comprising:
a rod body;
a fishing reel including a line winding mechanism; and
the motion capture device according to claim 13 arranged at the line winding mechanism.

15. A method for obtaining fishing rod fishing events comprising:
obtaining motion data of a winding mechanism at least partially arranged in a body frame of a fishing reel of a fishing rod, the motion data being collected by a motion capture device arranged at the line winding mechanism; and
determining a fishing event according to the motion data.

16. The method according to claim 15, wherein the motion data includes a rotation feature of the line winding mechanism.

17. The method according to claim 16, wherein determining the fishing event according to the motion data includes:
determining the fishing event as fish searching according to the rotation feature of the line winding mechanism.

18. The method according to claim 16, wherein:
the motion data further includes a movement feature of the line winding mechanism; and
determining the fishing event according to the motion data includes:
determining the fishing event as fish luring or fish hooking according to the rotation feature and the movement feature of the line winding mechanism.
